(19) United States
(12) Patent Application Publication
(10) Pub. No.: US 2012/0032645 A1
(43) Pub. Date: Feb. 9, 2012

(54) BATTERY PACK FOR PRACTICAL LOW-POWER MODE CURRENT DETECTION AND METHOD OF DETECTING EXCESSIVE CURRENT

(76) Inventors: Shinichi MATSUURA, Sumoto-shi (JP); Kazuhiro Toyoda, Sumoto-shi (JP)

(21) Appl. No.: 13/197,102

(22) Filed: Aug. 3, 2011

(30) Foreign Application Priority Data
Aug. 4, 2010 (JP) 2010-175576

(51) Int. Cl. H02J 7/04

(52) U.S. Cl. 320/134

(57) ABSTRACT

In a battery pack 10 control section 5 low-power mode, a comparator 81 is used to detect the voltage across a 2.5 mΩ current detection resistor 2 connected in the battery 1 charging and discharging path. When the detected voltage exceeds a voltage (2.4 mV) that is lower than the voltage (50 mV) for detecting a 20 A first over-current in the non-low-power mode, that occurrence is recorded in a register 82. When the register 82 holds occurrence of the voltage being exceeded and when a CTRL signal indicating the load device 20 is in the low-power mode is input to an I/O port 55, the control section 5 CPU 51 detects a second over-current of approximately 1 A, switches OFF the cut-off devices 7, and sends advisory data from a communication section 9 to a control and power source section 21 in the load device 20.

### BACKGROUND OF THE INVENTION

1. Field of the Invention

The present invention relates to a battery pack that detects voltage across a resistor in the rechargeable battery charging and discharging current path and performs prescribed operations, and to a method of detecting excessive current in the battery pack.

2. Description of the Related Art

If excessive current greater than the allowable current flows through rechargeable batteries housed in a battery pack, worst-case failure events such as rechargeable battery extreme heating, ignition, and explosion are possible. Consequently, prior art battery packs are provided with a current detection resistor and a switching device in the charging and discharging current path of the rechargeable batteries. When the voltage across the current detection resistor exceeds a given value, the switching device is turned OFF.

For example, Japanese Laid-Open Patent Publication 2007-124768 discloses a battery pack with a current detection resistor and field effect transistor (FET) in either or both the charging and discharging circuit paths of the rechargeable batteries. When excessive current such as short circuit current flows through the current detection resistor, the voltage detection circuit of this battery pack detects the rise in voltage across the current detection resistor and issues a signal to switch OFF the FET.

However, in the battery pack disclosed in JP 2007-124768, the voltage detection circuit is implemented in hardware, and the range of current settings for determining excessive current is constrained by the size of the current detection resistor.

For example, in the case where the electrical device supplied by current from the battery pack is in a low-power (energy-saving) mode, the size of the excessive current that should be detected by the battery pack is inevitably smaller than the excessive current value for detection when the electrical device is not in the low-power mode. Therefore, it is necessary to widen the range of current settings in the low-current direction to determine excessive current.

### SUMMARY OF THE INVENTION

However, if the excessive current detection range is widened by increasing the value of the current detection resistor, power loss in the current detection resistor during normal charging and discharging (not in the low-power mode) increases and temperature rise due to resistor heating cannot be neglected. Further, excessive current can be detected in the same way charging and discharging current is detected during normal charging and discharging control. For example, the voltage across the current detection resistor can be converted to a digital value by an analog-to-digital (A/D) converter and excessive current can be determined by software. In that case, excessive current is determined by time-sequence detection and has the problem that detection is delayed in time.

The present invention was developed considering the problems described above. Thus, it is an object of the present invention to provide a battery pack that can rapidly detect current in the low-power mode that is smaller that the current normally detected when not in the low-power mode without increasing power loss, and to provide a method of detecting excessive current in the battery pack.

The battery pack of the present invention is provided with rechargeable batteries, and a resistor connected in the rechargeable battery charging and discharging circuit path. The battery pack can operate in a reduced power consumption low-power mode and in a mode that is not the low-power mode (non-low-power mode). When not in the low-power mode and when the voltage detected across the resistor exceeds a first voltage, the battery pack performs first operations. The battery pack is provided with an input section where a prescribed signal is input, an input decision section that determines whether or not a signal has been input to the input section, and a voltage decision section that determines whether or not the voltage detected across the resistor in the low-power mode exceeds a second voltage that is lower than the first voltage. The battery pack is characterized by an architecture that performs the first operations or second operations, which are different than the first operations, when the voltage decision section determines that the voltage exceeds the second voltage and the input decision section determines that a signal has been input.

The battery pack of the present invention is provided with a memory section that records occurrence of the detected voltage exceeding the second voltage. When the detected voltage exceeds the second voltage, the voltage decision section stores that occurrence in the memory section, and when that occurrence has already been stored in the memory section, the voltage decision section judges that the detected voltage exceeds the second voltage.

The battery pack of the present invention is characterized in that the prescribed signal is a signal indicating that the external electrical device for charging and discharging the rechargeable batteries is in the (second) low-power mode.

The battery pack of the present invention is characterized by provision of switching devices connected in the rechargeable battery charging and discharging circuit path, and the second operations include switching the switching devices OFF.

The battery pack of the present invention is characterized by provision of a communication section to communicate with the external electrical device, and the second operations include writing data into the communication section to notify the electrical device.

The battery pack of the present invention is characterized in that the first operations include detecting a first over-current flowing in the resistor based on the voltage across the resistor, and the second operations include detecting a second over-current, which is smaller than the first over-current, based on the voltage across the resistor.

The method of detecting excessive current of the present invention detects a second over-current that is smaller than a first over-current in a battery pack provided with rechargeable batteries and a resistor connected in the rechargeable battery charging and discharging circuit path; the battery pack can operate in a reduced power consumption low-power mode and in a mode that is not the low-power mode, and detects the first over-current when not in the low-power mode and when resistor voltage exceeding a first voltage is detected. The method determines whether or not a signal has been input to an input section, which is provided to input a prescribed signal, and determines whether or not the detected resistor voltage in the low-power mode exceeds a second voltage that is lower than the first voltage. The method is characterized by detecting the second over-current when it is judged that resistor voltage exceeds the second voltage and a signal has been input.

In the method of detecting excessive current of the present invention, a memory section is provided that records occurrence of the detected voltage exceeding the second voltage. When the detected voltage exceeds the second voltage, that occurrence is stored in the memory section, and when that occurrence has already been stored in the memory section, the detected voltage is judged to exceed the second voltage.

In the present invention, a first current and a second current are obtained by dividing the first voltage and the second voltage respectively by the value of the resistor in the rechargeable battery charging and discharging circuit path. When not in the low-power mode and the when the first current is detected, the first operations are performed. During the period when a prescribed signal has been input in the low-power mode and when the second current is detected, the first operations or the second operations are performed. For example, the first operations and the second operations switch OFF the switching devices and send prescribed data. Consequently, when a prescribed signal has been input in the low-power mode and when the second current, which is smaller than the first current that can be detected when not in the low-power mode, is detected, the first operations or the second operations are performed. When second current detection is implemented primarily in hardware, detection delay can be reduced while tending to eliminate detection-escape. Further, since a common resistor is used for first current and second current detection, no increase in power loss is incurred by enabling detection of the second current.

The second current can be detected for all types of purposes as long as it is sufficiently smaller than the first current. For example, with over-current detected by the first current, the second current detected in the low-power mode can be a small current that triggers transition from the low-power mode to the non-low-power mode. In that case, when a prescribed signal indicates from the perspective of the external device that the small current should not flow, the second current can be detected as an over-current that is smaller than the over-current detected by the first current.

In the present invention, when resistor voltage detected in the low-power mode is greater than the second voltage, that occurrence is stored in the memory section. Subsequently, when that occurrence is determined to be stored in the memory section, resistor voltage is judged to be greater than the second voltage. As a result, it can be determined if the detected resistor voltage is greater than the second voltage after that voltage has been detected. Consequently, when resistor voltage detection and memory section storage are implemented primarily in hardware and are performed at high speed, even if judgment by the voltage decision section has a time delay, the second current can be detected without detection-escape.

In the present invention, a signal indicating the external electrical device is in a second low-power mode such as a standby mode is input as the prescribed signal. Accordingly, the externally input prescribed signal indicates the external electrical device is operating in a second low-power mode that consumes less power than in a normal operating mode, and the battery pack should detect a second current that is smaller than the first current. Specifically, since the external electrical device is in the second low-power mode, power consumption is reduced. Since the prescribed signal indicates the second current, which is smaller than the first current, should not flow in that operating mode, the second current is detected for example, as an over-current.

In the present invention, when the second operations are performed, the switching devices in the charging and discharging circuit path are switched OFF. As a result, battery pack safety is insured by turning the switching devices OFF to cut-off rechargeable battery current when the second current is detected.

In the present invention, when the second operations are performed, information for external electrical device notification is written into the communication section. Accordingly, when the second current is detected, prescribed data are written into the communication section, and the transcribed data are sent to the electrical device as advisory information for operator notification.

For the present invention in the non-low-power mode, the first current based on the voltage across the resistor is detected as the first over-current. In the low-power mode, the second current, which is smaller than the first current, is detected as the second over-current. Consequently, a large over-current and a small over-current (two over-currents) are detected by the resistor in the charging and discharging path. Further, even when there is a small current, which may not be detectable as over-current in the non-low-power mode but is a value that normally should not flow in the low-power mode, it is detected as over-current.

In the present invention, when the first current and the second current are obtained by dividing the first voltage and the second voltage respectively by the resistor value and when the second current is detected in the low-power mode during a period of prescribed signal input, the first operations or the second operations are performed. Accordingly, when a prescribed signal has been input in the low-power mode and when the second current, which is smaller than the first current that is detectable in the non-low-power mode, is detected, the first operations or the second operations are performed. When second current detection is implemented primarily in hardware, detection delay can be reduced while tending to eliminate detection-escape. Further, since a common resistor is used for first current and second current detection, no increase in power loss is incurred by enabling detection of the second current. Consequently, a current that is smaller than the current normally detectable in the non-low-power mode can be rapidly detected in the low-power mode without increasing power losses. The above and further objects of the present invention as well as the features thereof will become more apparent from the following detailed description to be made in conjunction with the accompanying drawings.

### BRIEF DESCRIPTION OF THE DRAWINGS

FIG. 1 is a block diagram showing an example of battery pack structure for an embodiment of the present invention;

FIG. 2 is a state diagram showing transitions between the three operating states of the control section;

FIG. 3 is a table showing examples of current values detectable by the comparator; and

FIG. 4 is a flowchart showing the central processing unit (CPU) processing procedure to detect excessive current in the low-power mode.

### DETAILED DESCRIPTION OF THE EMBODIMENT(S)

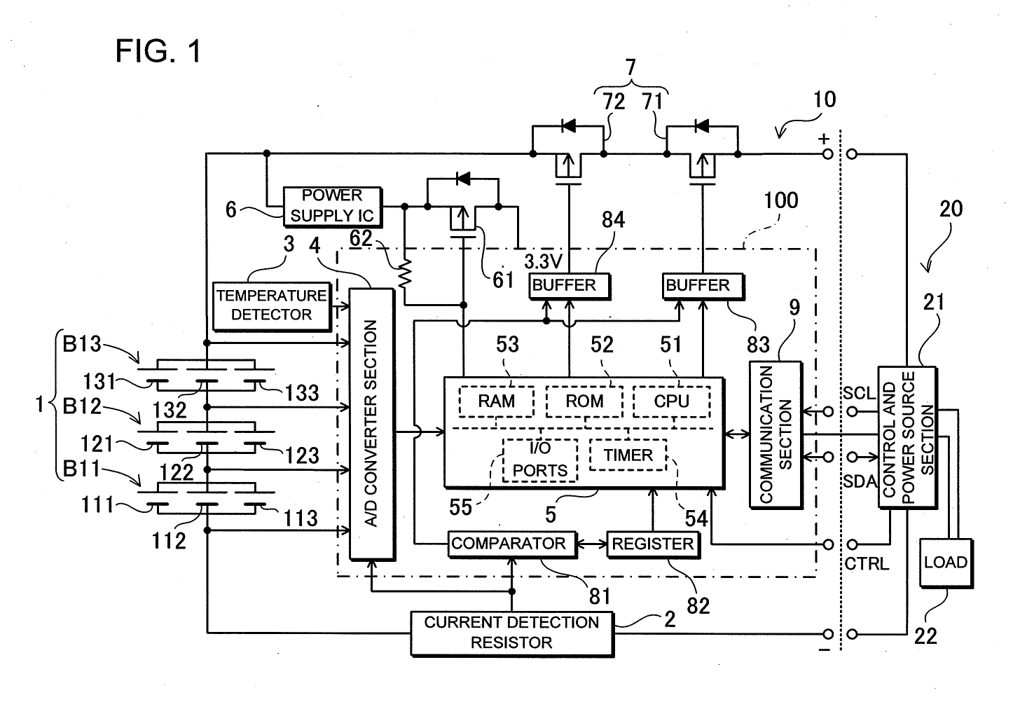

The following describes embodiments of the present invention based on the figures. FIG. 1 is a block diagram showing an example of battery pack structure for an embodiment of the present invention. The battery pack 10 of the figure attaches in a detachable manner to a load device 20 such as a personal computer (PC) or other portable terminal device. The battery pack 10 is provided with a battery 1 made up of lithium ion rechargeable battery cells 111, 112, 113, 121, 122, 123, 131, 132, 133 connected in parallel and in numerical order in three groups as battery blocks B11, B12, B13, which are in-turn connected in series. The positive electrode of the battery block B13 and the negative electrode of the battery block B11 are the positive and negative electrode terminals of the battery 1.

The voltage of each battery block B11, B12, B13 is independently input to an analog input terminal of an analog-to-digital (A/D) converter section 4, and converted to a digital value that is output to a microcomputer control section 5 from the A/D converter section 4 digital output terminal. Output from a temperature detector 3 disposed in thermal connection with the battery 1 to detect battery 1 temperature via circuitry including a thermistor, and output from a current detection resistor 2 connected on the negative electrode terminal-side of the battery 1 in the charging and discharging circuit path to detect battery 1 charging and discharging current are also input to A/D converter section 4 analog input terminals. These detected values are also converted to digital values that are output to the control section 5 from the A/D converter section 4 digital output terminal. Current detection resistor 2 output is also input to a comparator 81 that detects a set current determined by a value pre-loaded in a register 82. Comparator 81 output is input to buffers 83, 84 described later.

Cut-off devices 7, which are P-channel metal-oxide-semiconductor field-effect transistors (MOSFETs) 71, 72, are connected in the charging and discharging path on the positive electrode terminal-side of the battery 11 to cut-off charging and discharging current. The MOSFETs 71, 72 are connected in series with their drains connected at a common node. The diode connected between the source and drain in parallel with each MOSFET 71, 72 is the parasitic (drain-body) diode. Further, the input terminal of a power supply (regulator) integrated circuit (IC) 6 is also connected in the charging and discharging path on the positive electrode terminal-side of the battery 11. The power supply IC 6 provides stabilized 3.3V direct current (DC) power through the source and drain of a P-channel MOSFET 61 to the 3.3V power input of a control section circuit board 100 that carries the control section 5. A resistor 62 is connected between the source and gate of the MOSFET 61.

The control section 5 has a central processing unit (CPU) 51. The CPU 51 is connected through a bus with read-only memory (ROM) 52 that stores information such as programs, random access memory (RAM) 53 that stores generated data temporarily, a timer 54 for time measurements, and input-output (I/O) ports 55 for communication with each section in the battery pack 10. I/O ports 55 are connected with the A/D converter section 4 digital output terminal, the buffers 83, 84 that transmit ON and OFF signals to gate of each MOSFET 71, 72, the register 82 that holds comparator 81 detection data and the set value for the comparator 81, and the communication section 9 that receives a control (CTRL) signal and communicates with the load device 20 control and power source section 21 (described later). When a buffer 83, 84 receives either a detection level from the comparator 81 or an OFF signal from an I/O port 55, it transmits it as an OFF signal to the gate of a MOSFET 71, 72. Here, at least the control section 5, the A/D converter section 4, the comparator 81, the register 82, the buffers 83, 84, and the communication section 9 are mounted on the control section circuit board 100.

The CPU 51 performs functions such as arithmetic operations and input-output operations according to a control program pre-stored in ROM 52. For example, the CPU 51 reads-in battery block B11, B12, B13 voltages and the detected charging and discharging current value with a set periodicity (such as 250 ms), integrates the remaining capacity of the battery 1 based on the acquired voltage and detection values, and stores the results in RAM 53. The CPU 51 also generates remaining capacity data that are written to a register (not illustrated) in the communication section 9, where that remaining capacity data are output. The ROM 52 is non-volatile memory such as electrically erasable programmable read-only memory (EEPROM) or flash memory, and besides programs the ROM 52 stores a self-modifying battery capacity, the charging and discharging cycle count, and various settings (constants).

When the comparator 81 output level indicates no-detection, a LOW (L) level ON signal is issued from the I/O ports 55 to the cut-off device 7 MOSFET 71, 72 gates via the buffers 83,84 to establish source-to-drain conduction. In the case of battery 1 charging current cut-off, a HIGH (H) level OFF signal is sent to the gate of the MOSFET 71 from an I/O port 55 via the buffer 83 to cut-off source-to-drain conduction. Similarly, for battery 1 discharging current cut-off, a HIGH level OFF signal is sent to the gate of the MOSFET 72 from an I/O port 55 via the buffer 84 to cut-off source-to-drain conduction. When the battery 1 is appropriately charged, both cut-off device 7 MOSFETs 71, 72 are turned ON in a state that allows battery 1 charging and discharging.

The load device 20 is provided with a load 22 connected to a control and power source section 21. Although not illustrated, the control and power source section 21 supplies power from a commercial power source to drive the load 22 and supply charging current to the battery 1 charging and discharging circuit. In addition, when power is not supplied from the commercial power source, the control and power source section 21 drives the load 22 with discharging current supplied from the battery 1 charging and discharging circuit. When the battery 1 is made up of lithium ion batteries, the control and power source section 21 performs constant current-constant voltage charging while regulating maximum current (to approximately 0.5 to 1 C) and maximum voltage (to approximately 4.2V/cell to 4.4V/cell). When battery 1 terminal voltage becomes a set voltage or greater and charging current becomes a set current or lower, full-charge is determined.

Communication between the control and power source section 21 and the communication section 9 is implemented according to System Management Bus (SMBus) protocol with the control and power source section 21 as the master and the communication section 9 as the slave. In this case, the serial clock (SCL) is supplied by the control and power source section 21 and serial data (SDA) is sent in both directions between the control and power source section 21 and the communication section 9. In the present embodiment, the control and power source section 21 polls the memory section 9 with a 2 sec period and reads-in the contents of the previously described communication section 9 register. For example, this polling transfers battery 1 remaining capacity data from the communication section 9 to the control and power source section 21 every 2 sec, and the remaining capacity value is indicated as a percentage by a display (not illustrated) in the load device 20. The 2 sec polling period described above is a value set by the control and power source section 21. Separate from communication described above, a control (CTRL) signal is issued from the control and power source section 21 to the control section 5. The CTRL signal becomes an ON signal when the load device 20 goes into a low-power mode such as a standby mode.

The remaining capacity of the battery 1 is computed as integrated current or integrated power by subtracting the discharged capacity from the battery 1 self-modifying capacity (with units of Ah or Wh). Remaining capacity is expressed as a percentage with the self-modifying capacity as 100%. The self-modifying capacity of the battery 1 can be the discharge current or discharge power integrated during the period of discharge from full-charge to the discharge halting voltage, or it can be the charging current or charging power integrated from the discharged state (at the discharge halting voltage) to a state of full-charge. Although the control section 5 continuously consumes several hundred μA of current while integrating the remaining capacity, it shuts-down to prevent over-discharging the battery 1 when the voltage of any battery block B11, B12, B13 drops below the discharge halting voltage. In that case, current leakage from the battery 1 is reduced to the order of 30 μA.

When the control section 5 shuts-down, the potential becomes the same at both ends of the resistor 62 between the source and gate of the MOSFET 61 connected to the output terminal of the power supply IC 6 and the MOSFET 61 is held in the OFF state. In that state, if the control and power source section 21 begins charging the battery 1, an ON signal (issued from a circuit that is not illustrated) forces the gate LOW to turn ON the MOSFET 61 and release the control section 5 from shut-down. Immediately after the control section 5 CPU 51 begins operating, a LOW level ON signal is continuously applied to the gate of the MOSFET 61. When CPU 51 operation shuts-down the control section 5, a HIGH level OFF signal is applied to the gate of the MOSFET 61.

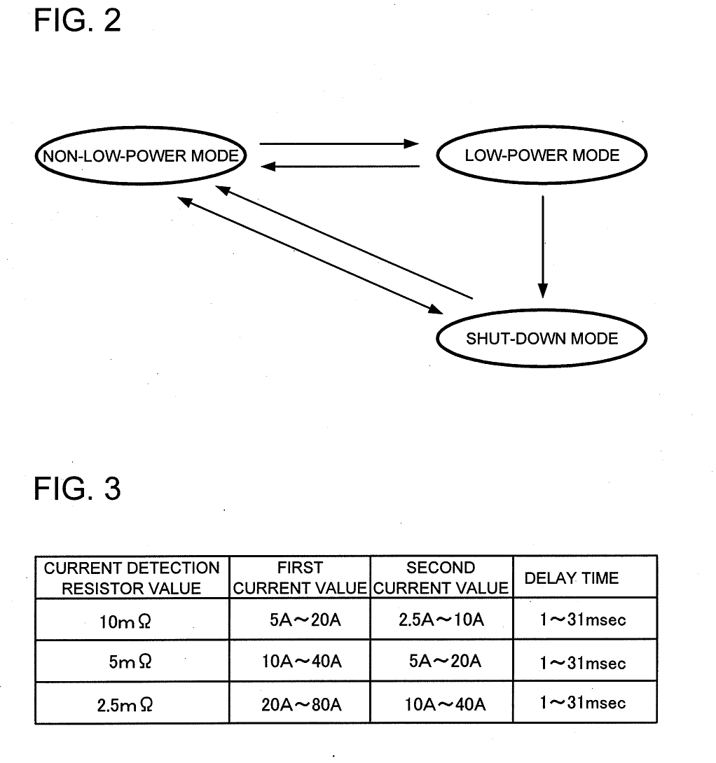

The following describes the operating states of the control section 5. FIG. 2 is a state diagram showing transitions between the three control section 5 operating states. When the battery pack 10 is charging and discharging in normal operation, the control section 5 is in the non-low-power mode. As described above, when the control section 5 is in the shut-down mode, 3.3V is no longer supplied to the control section 5. Although not illustrated, the CPU 51 is supplied with 4 MHz and 32 KHz clock signals from a clock generating section. When the control section 5 is in the low-power mode, power consumption is reduced by halting the 4 MHz clock.

The control section 5 transitions from the non-low-power mode to the low-power mode when, for example, condition (1) is satisfied and either condition (2) or condition (3) is satisfied. Condition (1) is 0 mA≦discharging current≦100 mA. Condition (2) is the serial data (SDA) or the serial clock (SCL) remain LOW for 2 sec or more. Condition (3) is loss of communication between the communication section 9 and the control and power source section 21 for a given time period (for example, 4 sec). The control section 5 transitions from the low-power mode to the non-low-power mode when any of the conditions (4)-(6) is satisfied. Condition (4) is communication established between the communication section 9 and the control and power source section 21. Condition (5) is discharging current>100 mA. Condition (6) is charging current>0 mA.

The condition for control section 5 transition from either the non-low-power mode or the low-power mode to the shut-down mode is the voltage of any battery block B11, B12, B13 dropping to or below a set voltage (for example, 2.3V). The condition for control section 5 transition from the shut-down mode to the non-low-power mode is application of approximately 5V or more to the battery 1 charging and discharging circuit, and as described previously, forcing the gate of the MOSFET 61 to a LOW level (ON signal).

The following describes current detection via the comparator 81. FIG. 3 is a table showing examples of current values detectable by the comparator 81. For example, when the absolute value of the voltage across the current detection resistor 2 is either in a range from 50 mV to 200 mV or from 25 mV to 100 mV, the comparator 81 can detect current as either a first current value or a second current value respectively. Current detectable as the first current value or the second current value and the delay time are determined by the value set in the register 82 by the CPU 51 through an I/O port 55. To limit current detection resistor 2 heat generation during normal charging and discharging, the present embodiment uses a 2.5 mΩ resistor as the current detection resistor 2. Here the register 82 is loaded with a suitable value to detect, for example, a 20 A over-current by the first current value (called first over-current below). If the comparator 81 detects the first over-current, a detection signal is transmitted to the gates of the MOSFETs 71, 72 via the buffers 83, 84 and charging and discharging current is cut-off.

Detection of the first over-current by the first current value described above assumes the load device 20 is in a normal operating mode that has the possibility of inducing excessive discharging current. However, an over-current (called second over-current below) that is smaller than the first over-current must be detected when the load device 20 is in a low-power mode such as a standby mode. In that case, if the detected output of the current detection resistor 2 is converted to a digital value by the A/D converter section 4 and the converted digital value is periodically read-into the CPU 51 to detect the second over-current, there is a good chance for detection-escape and detection delay.

On the other hand, the comparator 81 used in the present embodiment has the ability (function) to supply data that can trigger control section 5 transition from the low-power mode to the non-low-power mode. For example, when current is detected corresponding to an absolute value of the voltage across the current detection resistor 2 from 2 mV to 10 mV, that detection sets a wake-bit in the register 82. Here, the comparator 81 function described above is used to detect approximately 1 A of current. Accordingly, the register 82 is loaded with a suitable value to detect a current corresponding to an absolute value of the voltage across the current detection resistor 2 of 2.4 mV (which is approximately 1 A times 2.5 mΩ). Since current detected in this manner is accomplished via comparator 81 hardware, detection-escape is eliminated and detection delay is reduced.

Incidentally, as described using FIG. 2, when the control section 5 is in the low-power mode, the condition that 0 mA≦discharging current≦100 mA is satisfied, and either the condition that SDA or SCL remain LOW for 2 sec or more, or the condition that communication is lost for a given time period between the communication section 9 and the control and power source section 21 is satisfied. Therefore, the load device 20 is in effect in a low-power mode such as a standby mode. However, when the load device 20 transitions from the low-power mode to the non-low-power mode, it is possible for a discharge current of 1 A or more to temporarily flow in the battery pack 10. Consequently, a strategy is required to avoid mistakenly detecting that temporary discharge current as second over-current.

Accordingly, in the present embodiment, when the load device 20 is in the low-power mode, a CTRL signal indicating the validity of second over-current detection is sent from the control and power source section 21 to the control section 5. The CTRL signal is not limited to a signal indicating the load device 20 is in the low-power mode, and can be any signal indicating a period when second over-current detection is valid. The CTRL signal is held ON for at least the period when communication is established between the control and power source section 21 and the communication section 9 and until the control section 5 has transitioned to the non-low-power mode. As a result, when the CPU 51 determines that the register 82 wake-bit is ON along with an ON CTRL signal, the second over-current can be detected in the low-power mode without error. Here, when the comparator 81 detects a current of 1 A as described above, it is not necessarily required to set a wake-bit and have the CPU 51 detect that bit ON. For example, hardware implementation can be arranged to detect second over-current only when the CTRL signal is determined to be in the ON state.

When second over-current is detected, the CPU 51 switches OFF the MOSFETs 71, 72 via the I/O ports 55 and buffers 83, 84 to cut-off charging and discharging current and writes advisory data into the communication section 9 to notify the load device 20. The communication section 9 is polled by the control and power source section 21, the advisory data are read into the load device 20, and the operator is notified.

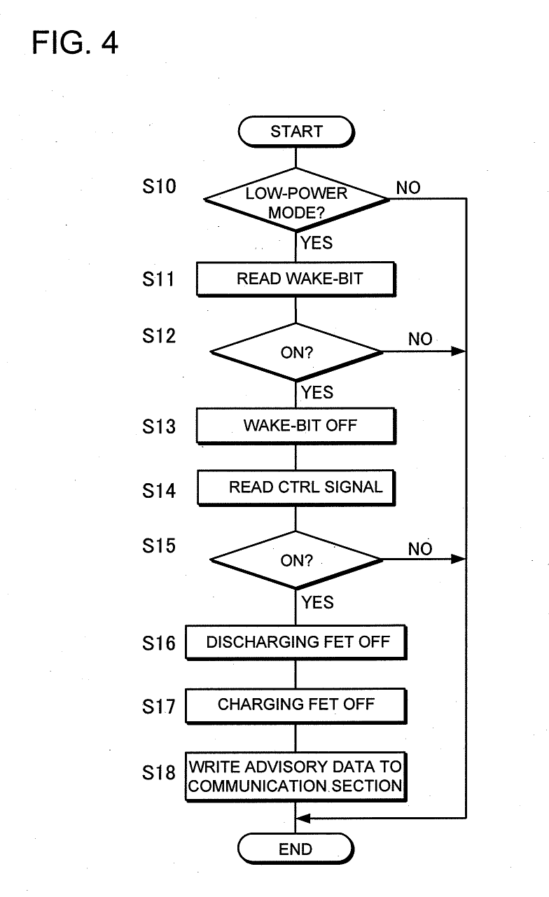

The following describes control section 5 processing in detail using a flowchart. Processing described below is performed by the CPU 51 according to a control program pre-stored in ROM 52. FIG. 4 is a flowchart showing the CPU 51 processing steps to detect excessive current in the low-power mode. When the control section 5 transitions from the non-low-power mode to the low-power mode, the flowchart procedure is executed with a given periodicity (for example, with a 32 ms period). Further, when transitioning from the non-low-power mode to the low-power mode and prior to executing the following processing steps, certain settings are loaded into the register 82. As a result, a comparator 81 operating mode is established where the comparator 81 sets a wake-bit when approximately 1 A of current flow is detected through the current detection resistor 2. In contrast, when transitioning from the low-power mode to the non-low-power mode, a comparator 81 operating mode is established where the wake-bit is not set. In addition, data indicating whether or not the control section 5 is in the low-power mode are stored in RAM 53.

When FIG. 4 processing is executed, the. CPU 51 determines whether or not the control section 5 is in the low-power mode (S10). If the control section 5 is in the low-power mode (S10: YES), the CPU 51 reads-in the register 82 wake-bit via an I/O port 55 (S11) and determines whether or not the wake-bit is ON (S12). If the wake-bit is ON (S12: YES), the CPU 51 turns the wake-bit OFF for subsequent over-current detection (S13), reads-in the CTRL signal via an I/O port 55 (S14), and determines whether or not the CTRL signal is ON (S15). If the CTRL signal is ON (S15: YES), the CPU 51 switches OFF the discharging MOSFET 72 to cut-off discharging current (S16) and switches OFF the charging MOSFET 71 to cut-off charging current (S17). Here, it is also possible to switch OFF only the discharging MOSFET 71 to cut-off discharging current. Subsequently, the CPU 51 writes data indicating second over-current detection in the low-power mode to a register (not illustrated) in the communication section 9 (S18) to complete the processing procedure.

In step S10, if the control section 5 is not in the low-power mode (S10: NO), or in step S12, if the wake-bit is not ON (S12: NO), or in step S15, if the CTRL signal is not ON (S15: NO), the CPU 51 completes the procedure with no further processing.

According to the present embodiment as described above, voltage across the current detection resistor connected in the battery charging and discharging path is detected in the low-power mode. When the detected voltage exceeds 2.4 mV (approximately 1 A times 2.5 mΩ), which is smaller than 50 mV (20 A times 2.5 mΩ) detected for the 20 A first over-current in the non-low-power mode, and an ON CTRL signal is input to an I/O port, a second over-current of approximately 1 A is detected and the second operations are performed. In other words, when a current of approximately 1 A, which is smaller than the 20 A over-current that can be detected in the non-low-power mode, is detected in the low-power mode and a CTRL signal is input indicating that detection in the low-power mode is valid, the second over-current is detected and the second operations are performed. Since the detection of approximately 1 A as described above is implemented by comparator hardware, detection delay is reduced without detection-escape. Further, since a common resistor is used for first over-current and second over-current detection, no increase in power loss is incurred by enabling detection of the second over-current (which is smaller than the first over-current). Consequently, a current that is smaller than the current normally detectable in the non-low-power mode can be rapidly detected in the low-power mode without increasing power losses.

When the current detection resistor voltage detected by the comparator in the low-power mode is greater than 2.4 mV, that detection is stored by setting the register wake-bit. If it is subsequently determined that the register wake-bit is set, current detection resistor voltage can be judged greater than 2.4 mV. Specifically, detected voltage can be judged greater than 2.4 mV after reliable high speed detection of the current detection resistor voltage and storage of that detection by comparator and register hardware. Therefore, even if CPU processing is delayed following detection of the current detection resistor voltage, the second current can be detected without detection-escape.

In addition, a CTRL signal indicating that the external load device is in the low-power mode is input to an I/O port as a signal that asserts the validity of second over-current detection. Accordingly, the CTRL signal can indicate that the external load device is in the low-power mode that consumes less power than in the normal operating mode, and the battery pack should detect a second current that is smaller than the first current.

Further, when the second operations are performed, the MOSFETs connected in the battery charging and discharging path are switched OFF. As a result, battery pack safety can be insured by switching the MOSFETs OFF to cut-off battery charging and discharging current when the second over-current is detected.

Further, when the second operations are performed, advisory data for external load device notification are written into the communication section register. Accordingly, when the second over-current is detected, data indicating detection are written into the communication section, and the transcribed data are sent to the external load device allowing the operator to be advised.

Further, based on the voltage across the current detection resistor, 20 A of current flow through the current detection resistor is detected as the first over-current in the non-low-power mode, and approximately 1 A of current is detected as the second over-current in the low-power mode. Consequently, a large over-current and a small over-current (two over-currents) can be detected by a single current detection resistor in the charging and discharging path. Further, even a small current on the order of 1 A, which may not be detectable as an over-current in the non-low-power mode, can be detected as over-current in the low-power mode because a current of that value normally should not flow in the low-power mode.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2010-175576 filed in Japan on Aug. 4, 2010, the content of which is incorporated herein by reference.

What is claimed is:

1. A battery pack comprising:
rechargeable batteries;
a resistor connected in the rechargeable battery charging and discharging circuit path where operation is possible in a reduced power consumption low-power mode and in a non-low-power mode, and when detected resistor voltage exceeds a first voltage in the non-low-power mode, first operations are performed;
an input section where a prescribed signal is input;
an input decision section that determines whether or not a signal has been input to the input section; and
a voltage decision section that determines whether or not the voltage detected across the resistor in the low-power mode exceeds a second voltage that is lower than the first voltage,
wherein when the voltage decision section determines that detected voltage exceeds the second voltage and the input decision section determines that a signal has been input, the battery pack is configured to perform the first operations or second operations, which are different than the first operations.

2. The battery pack as cited in claim 1 wherein a memory section is provided that records occurrence of detected voltage exceeding the second voltage;
when detected voltage exceeds the second voltage, the voltage decision section stores that occurrence in the memory section; and further, when that occurrence has been stored in the memory section, the battery pack is configured to judge the detected voltage greater than the second voltage.

3. The battery pack as cited in claim 1 wherein the prescribed signal is a signal indicating that an external electrical device for charging and discharging the rechargeable batteries is in the second low-power mode.

4. The battery pack as cited in claim 1 wherein switching devices are provided in the rechargeable battery charging and discharging path, and the second operations include switching the switching devices OFF.

5. The battery pack as cited in claim 1 wherein a communication section is provided to communicate with an external electrical device, and the second operations include writing advisory data into the communication section to notify the electrical device.

6. The battery pack as cited in claim 1 wherein the first operations include detecting a first over-current flowing in the resistor based on the voltage across the resistor, and the second operations include detecting a second over-current, which is smaller than the first over-current, based on the voltage across the resistor.

7. A method of detecting excessive current that detects a second over-current that is smaller than a first over-current in a battery pack provided with rechargeable batteries and a resistor connected in the rechargeable battery charging and discharging path where operation is possible in a reduced power consumption low-power mode and in a non-low-power mode, and when detected resistor voltage exceeds a first voltage in the non-low-power mode, first operations are performed, the method comprising:
establishing an input section for inputting a prescribed signal;
determining whether or not a signal has been input to the input section;
determining whether or not detected resistor voltage in the low-power mode exceeds a second voltage that is lower than the first voltage; and
detecting the second over-current when it is judged that the second voltage has been exceeded and a signal has been input.

8. The method of detecting excessive current as cited in claim 7 wherein a memory section is established that records occurrence of the detected voltage exceeding the second voltage; when detected voltage exceeds the second voltage, that occurrence is stored in the memory section; and when that occurrence has been stored in the memory section, the detected voltage is judged to exceed the second voltage.
